(19) United States
(12) Patent Application Publication
(10) Pub. No.: US 2008/0143553 A1
(43) Pub. Date: Jun. 19, 2008

(54) Versatile telemetry base

(76) Inventors: John R.B. Lighton, Las Vegas, NV (US); Lance Anjin Fesler, Las Vegas, NV (US)

Correspondence Address: THE LUTHER LAW FIRM, 12198 E. COLUMBINE DR., SCOTTSDALE, AZ, 85259, US

(21) Appl. No.: 11/953,599

(22) Filed: Dec. 10, 2007

Related U.S. Application Data
(60) Provisional application No. 60/869,286, filed on Dec. 8, 2006.

(51) Int. Cl. G08C 15/06

(52) U.S. Cl. 340/870.02

(57) ABSTRACT

A telemetry base receives signals from at least one telemeter implanted in at least one animal. The base includes the following: a. a plurality of antennae to receive radiofrequency (RF) signals from the telemeter(s); b. a plurality of multiplexers connected to the antennae to increase the RF signal strength; c. at least one receiver circuit capable of processing RF signals from the antennae into electrical impulses; d. a central processing unit (CPU) to receive and process the electrical impulses into at least one parameter such as temperature; e. at least one digital address bus connected to the CPU and the multiplexer to select the antenna based on the best signal integrity of the antenna; f. a display to show the current parameters from the telemeters for analysis by the operator; and g. at least one analog-to-digital interface for receiving data from other external sensors.

### TECHNICAL FIELD

This application is in the field of respirometry, and more specifically regards telemetry of information from a plurality of animals.

### BACKGROUND OF THE INVENTION

The core body temperature of a laboratory animal, and often other physiological parameters, is often measured with an implanted radio frequency telemeter that is modulated at a frequency proportional to temperature. The telemeter may be self-powered, or powered via an applied electromagnetic field. The telemeter should not interfere with adjacent telemeters, and because it is usually used within the crowded confines of an animal care facility it has a limited range of 20-30 cm or has a unique ID code. Telemeters of this general kind are manufactured by several vendors, and large numbers of them are in existence in scientific and pharmaceutical facilities around the world. Currently available telemeters may measure several parameters in addition to temperature; we will mostly be discussing temperature-only telemeters here, but the principles outlined here are equally applicable to the reception and processing of data other than temperature.

Various vendors make receiver bases for the above-mentioned telemeters. The base generally sits beneath a plastic cage, picking up with its antenna the signal transmitted from a telemeter implanted in the caged animal. It can alternatively receive the telemetry signal via an external antenna, especially if the animal is housed in a metal cage. In a typical implementation, each base sends the telemetered data to a collection node, in analog or digital form depending on the vendor. The node acts as a gateway between the bases and a program running on a computer. Known telemetry receiver bases designed to receive analog telemetry signals that do not contain embedded timing information share certain common characteristics listed below:

1. Bases contain at most two receiving antennas, typically of the ferrite rod type.
2. Bases display only rudimentary information, such as on/off or carrier detect, with simple LED panel lights.
3. Bases cannot control external devices via logic-level outputs (for example, lights, bells or heaters).
4. Bases cannot read local analog voltages (for example, from attached instruments).
5. Bases cannot count local switch closures (for example, from running-wheels).
6. Bases cannot obtain other ambient environmental information such as relative humidity.
7. Bases generally cannot be used in groups of more than 4 or 16 per node, depending on the vendor; however, some vendors makes “supernodes” that allow multiple nodes to be deployed at substantial extra cost.
8. Bases cannot be more than an absolute maximum of 100 m distant from a node; much shorter distances are possible with analog base outputs.
9. Bases are not individually re-programmable with calibration data and other information for a specific telemeter.
10. Bases are “dumb”, and perform little or no signal processing to mitigate dropouts and other signal errors.

The combination of a telemetry receiver base, node or supernodes, and data acquisition software in currently available commercial implementations suffers from serious limitations. For example, signal dropouts are common and bases that are sampled only occasionally (typically once a minute to once every several minutes) will often return poor data, because the probability of poor readings at any given moment may be significant, based on the state of the telemeter and its orientation with regard to the base unit's antenna or antennae. This causes erroneous readings, which moreover are of poor resolution because they are “snapshots” of data with a random measurement error. Another problem is accuracy. Commercially available telemeters are generally calibrated by their manufacturers at two points close to consensus mammalian body temperature (for example, 35 and 40° C.). However, many researchers work with heterothermic animals that may vary their body temperature over the range 3-40° C. Our investigations of currently available telemeter characteristics have shown that their modulation frequency is highly curvilinear with regard to temperature, and two-point calibrations will give massive errors over this range no matter where the two points are measured.

Current telemetry bases are very limited in their ability to provide visual feedback to the investigator. For example, the bases made by MiniMitter and Data Sciences International (DSI) display only an on-off light and, in the case of the DSI base, a carrier detect light. The DSI base also boasts a card-holder for displaying handwritten information.

Current bases contain at most two antennae, typically of the ferrite rod type, at right angles to each other to maximize pickup. The result of this paucity of antennae is that drop-outs with data loss are frequent and a source of much frustration to investigators. Increasing the sensitivity of the associated receiver is not a solution, because “the wider you open the window, the more dirt blows in.” Also, current bases are single-purpose instruments. They do not provide any additional data acquisition or control capability.

Current telemetry bases with limited antennae do not capture all the data or coordinate with other instruments. This can lead to erroneous conclusions. Because of the inadvertent loss of data, the experimenter needs to include extra expensive animals. What are needed are not just reliably relayed signals but monitored and optimized signals and better real-time analysis, to enable the experimenter to only use the number of animals statistically required.

### SUMMARY OF THE INVENTION

In one embodiment there is provided a telemetry base for receiving signals from at least one telemeter implanted in at least one animal. The base includes the following: a) a plurality of antennae to receive radiofrequency (RF) signals from the telemeter(s); b) a plurality of multiplexers connected to the antennae to increase the RF signal strength; c) at least one receiver circuit capable of processing RF signals from the antennae into electrical impulses; d) a central processing unit (CPU) to receive and convert the electrical impulses into at least one parameter such as temperature; e) at least one digital address bus connected to the CPU and the multiplexer to select the antenna based on the best signal integrity of the antenna, f) a display to show the current parameters from the telemeters for analysis by the operator; and g) at least one analog-to-digital interface for receiving data from other external sensors.

Optionally, the telemetry base include at least one counter input line for external peripheral equipment. Optionally, the telemetry base includes at least one digital output line for controlling external instrumentation. Optionally the digital output line controls buzzers, lights, feeding hoppers or other serially controlled instruments. In another configuration the display of the telemetry base is also capable of displaying at least one reading related to at least one signal from at least one implanted telemeter.

Also disclosed is a method of receiving signals from at least one implanted telemeter. This method includes the following steps: a) providing a telemetry base having the following: i) a plurality of antennae to receive radiofrequency (RF) signals from at least one telemeter; ii) a plurality of multiplexers connected to the antennae to increase the RF signal strength; iii) at least one receiver circuit capable of converting RF signals from the antennae into electrical impulses; iv) a central processing unit (CPU) to receive and process the electrical impulses into at least one parameter such as temperature; v) at least one digital address bus connected to the CPU and the multiplexer to select the antenna based on the best signal integrity of the antenna; vi) a display to show the current parameters from the telemeters for analysis by the operator; and vii) at least one analog-to-digital interface for receiving data from other external sensors; b) receiving RF signals from at least one implanted telemeter via a plurality of antennae; c) transmitting the RF signals from the antennae to a multiplexer; d processing the RF signals in a receiver circuit into brief electrical impulses; e) transmitting the electrical impulses to the computer processing unit (CPU); f) comparing the electrical impulses from one antenna in the CPU against a variable, built-in reference voltage; g) adjusting the reference voltage so that the comparator fires repeatedly within the expected range of the telemeter's modulations frequency; and h) changing antennae until the best reference voltage is found by selecting antennae through a digital address bus.

### BRIEF DESCRIPTION OF DRAWINGS

FIG. 1 is a schematic showing the versatile telemetry receiver base (“apparatus”) in conceptual form.

FIG. 2 provides an overview of the components of an inventive base.

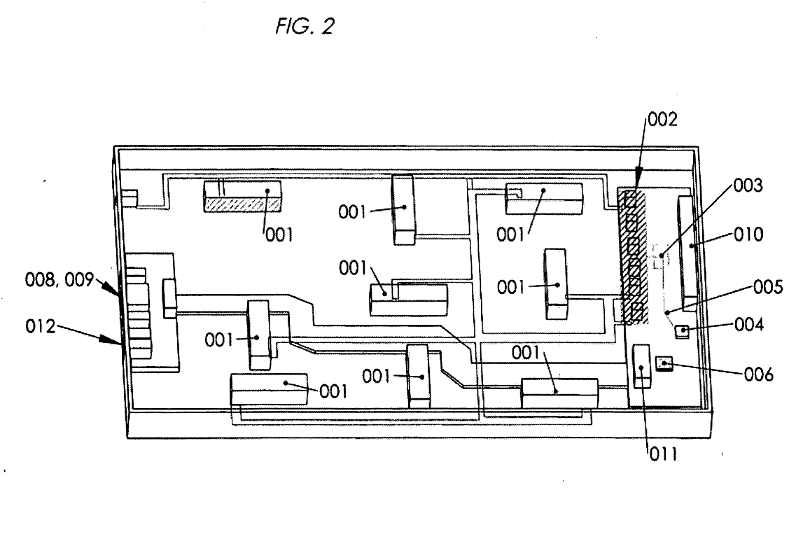

In the following detailed description of the preferred embodiments reference is made to the accompanying drawings that form a part hereof, and in which are shown by way of illustrating specific embodiments in which the invention may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of present inventions. The following detailed description, therefore, is not to be taken in a limiting sense, and the scope of various embodiments of the invention is defined only by the appended claims, along with the full range of equivalents to which such claims are entitled.

### DETAILED DESCRIPTION

The described invention represents a major advance in the utility and versatility of telemetry bases for laboratory animals. Our improved base design solves the problems of previous telemetry receiver-based designs. These new bases can be situated up to 1 km away from a single node, to which up to 250 or more individually addressable bases can be attached by daisy-chaining or other information transfer link. Each base contains calibration data for the telemeter it is associated with, and displays that telemeter's ID and actual temperature via a clear, legible display. Each inventive base “oversamples” temperature data every few seconds, and uses intelligent algorithms to detect dropouts and issue warnings thereby yielding maximally consistent data when interrogated by the node. Multiple statistical indices of data reliability are generated in each base and transmitted to the node that are designed to assist the user in data interpretation. Telemeter modulation frequencies are translated into temperature by improved precise non-linear mathematical techniques, with each telemeter's unique characteristics, unique serial number and calibration date stored in that base's non-volatile memory. Our inventive base can also store up to 256 characters of user-entered information in nonvolatile memory for record-keeping purposes. In contrast, our invention can measure locally generated analog voltages from external instruments, it can control devices via digital control lines, and it can count pulses or switch closures.

Instead of just the one or two antennae currently used, we have taken the novel approach of incorporating into the inventive base a plurality of doubled antennae, each of which consists of a pair of right-angle ferrite antennae. These are selected by a microcontroller (Central Processing Unit or CPU) based on signal integrity. Because each base contains a plurality of doubled antennae, and because the inventive base dynamically tracks signal strength and the antenna location yielding best data integrity, the location and degree of activity of the animal in the cage can be estimated in addition to other parameters such as core temperature.

In contrast to current telemetry bases, we have equipped our base with a visual display. Because calibration information and telemeter ID are present within the base, and because the base performs all relevant signal processing, each base can display the subject animal's telemeter ID, core body temperature and other parameters locally, giving invaluable real-time, in situ feedback to investigators, and a new opportunity for immediately correcting any problems.

Oar new telemetry receiver base does not need to be positioned close to a cage containing an experimental animal within which a telemeter is implanted. The output of the telemeter is modulated by temperature and/or other physiological variables. The base selects from a plurality of doubled antennae based on telemetry data integrity and is remotely programmed with the telemeter's calibration data, unique ID), and other information, which it processes for maximum reliability and resolution and can display locally on the telemetry receiver itself. The base can optionally measure ambient temperature and voltages from attached instrumentation, control digital outputs, and count pulses or switch closures. The inventive base has been designed to access up to 250 or more such bases may be accessed by a single digital link over a distance of up to 1 kilometer.

### EXAMPLE 1

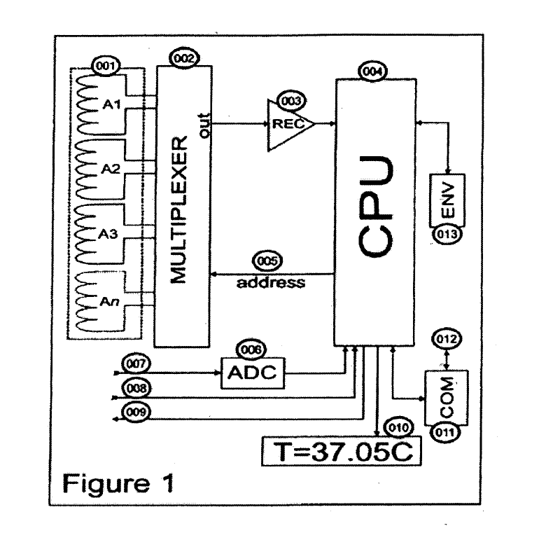

In FIG. 1 a plurality of doubled antennae 001 are arrayed within the base (for use with plastic animal cages) or above the cage (for use with metal animal cages). One or more of the antennae may, in a preferred implementation be external and of user design, such as by way of non-limiting example, an inductive loop antenna. The antennae 001 are connected to a multiplexer 002 and thence to a receiver circuit 003 that processes the RF bursts from the telemeter into brief pulses that are sent to the microcontroller (Central Processing Unit or CPU) 004. The pulse width is substantially less than the minimum inter-pulse duration that will be received from the implanted telemeter. Optionally, preamplifiers or receivers may be placed between the antennae 001 and the multiplexer 002. The CPU 004 selects the particular antenna 001 via the multiplexer 002 using a digital address bus 005, based on the integrity of the telemeter's signal.

Signal integrity can be assessed in a variety of ways. In a preferred implementation, the CPU 004 uses a built-in comparator to compare the incoming pulse from the receiver against a variable, built-in reference voltage. An example of a microcontroller with this capability is the PIC18F4525 (Microchip Technology Inc., Chandler, Ariz.). An antenna 001 is selected and the reference voltage is adjusted so that the comparator tires repeatedly within the expected range of the telemeter's modulation frequency. If this does not happen, another antenna 001 is selected. The best reception occurs at the antenna 001 ngiving the highest reference voltage and the most consistent inter-pulse duration. The base records the reference voltage and the antenna number giving the best reception, plus the number of peaks received with consistent inter-peak timing (which can vary from 0 with no reception to, in one preferred implementation, 32). These values can later be transmitted to the master node on request. The timing of each peak is recorded, in a preferred implementation in units of 0.1-1 μsecond. In a preferred implementation, the array of inter-peak timings is sorted into degrees of self-similarity, and the most self-similar timings and their submultiples are combined into a mean periodicity value, which is inverted to yield frequency.

The frequency, in one typical implementation, is converted to temperature or other physiological variable(s) by means of a polynomial transformation. In a preferred implementation the default polynomial is fifth degree and any unused coefficients are set to zero. The polynomial transformation may optionally be supplemented with other transformations. The transformation is created on a case-by-case basis for each telemeter unless the telemeter has an intrinsic calibration that causes its output to be interchangeable with others. The polynomial transformation is stored as individual coefficients (in a preferred implementation, the constant and 5 co-factors in the case of a 5-degree polynomial) in floating point form in the CPU's 004 non-volatile memory, together with the telemeter ID, the calibration date, and other data as required. CPUs 004 such as the Microchip PIC 18F4525 have 1024 addressable bytes of non-volatile (EEPROM) memory.

Optionally, only temperatures calculated from frequencies within a “known good” range, such as 30 Hz to 1 kHz with commonly available temperature telemeters, are stored. These temperatures are stored, in one preferred implementation, in a 16-step circular buffer. Each time a new temperature is stored, the circular buffer is sorted according to degree of self-similarity, and those temperatures differing from one another by less than a given amount (in a preferred implementation, <1%) are counted, summed, and divided by the count. The mean temperature is stored, together with the count, which acts as a further index of data integrity. For example, if data integrity is excellent, all 16 temperatures are self-similar and the index is 16, but if only 25% of the temperatures meet this criterion, the index is 4. Because telemeter readings are taken every few seconds, and telemeter data changes rather slowly relative to the refresh rate of the circular buffer in typical implementations, including arousal from hibernation, the resulting averaging reduces measurement noise while not impacting practical response speed.

In another configuration, an analog to digital converter (ADC) 006, which may have one or more analog channels converts one or more analog inputs (007) to digital form for transmission. The analog signals may come, by non-limiting way of example, from an instrument measuring a physiological or environmental parameter relevant to the caged animal.

Optionally, one or more counter inputs 008 allow switch closures or pulse inputs from peripheral equipment, such as a running wheel, to be counted and stored for later transmission.

In another configuration, one or more digital output lines 009 allow the control of external instrumentation, by way of non-limiting example, buzzers, lights, feeding hoppers or serially controlled instruments of any kind.

A display 010 shows one or more relevant readings derived from, or related to, the signal(s) from the implanted telemeter(s), such as, by way of non-limiting example, body temperature and/or heart rate, and the telemeter ID. The display 010 is driven from the CPU 004, and may be of any kind including but not limited to alphanumeric LCD or numeric or alphanumeric LED types. The display 010 also shows status information, including but not limited to the presence or absence of a telemeter signal and/or an assessment of a telemeter signal's data integrity. In an optional implementations the display may be supplemented with an analog output proportional to temperature, frequency, or other measured parameters), which can be recorded by a data acquisition system. The analog output would be derived from a digital to analog converter (not shown) driven from the CPU 004.

Communication between the CPU 004 and external data acquisition systems takes place via communication hardware 011 and an external communications link 012. The communication link 012 can be wired (typically via a serial multi-drop data link, in a preferred implementation using the RS485 physical layer in the communication hardware 011) or wireless transmission (examples being radio, infrared, ultrasonic or other).

The apparatus, in a preferred implementation, uses a “master-slave” protocol for communicating. A single master node attaches to a computer via a serial or USB port, or directly to a network. The master node communicates with the bases by sending a unique code corresponding to a given base, followed by a command and (in some implementations) one or more command parameters. The addressed base recognizes its unique code, and acts on the command, taking any supplied parameters into account. In a preferred implementation, the commands are single letters and include:

| COM- | PARAM- | |
|---|---|---|
| MAND | ETER(s) | RESPONSE |
| D | — | Base transmits a string of data comprising all |
| | | measured parameters plus telemeter ID, |
| | | calibration date and a checksum |
| C | Coefficient | Stores the coefficient in non-volatile memory for |
| | number, | converting telemetry data to user units, for |
| | floating | example, frequency to temperature via a fifth- |
| | point number | degree polynomial equation |
| I | Index, | Stores an information string, e.g. telemeter ID, |
| | 10-byte | date of calibration, and unique base identifier, |
| | string | depending on the value of Index |
| W | Address, | Write the byte to nonvolatile memory at the |
| | byte | supplied address |
| R | Address, | Read the byte to nonvolatile memory at the |
| | byte | supplied address |
| P | Number | Write the number to the digital output port for |
| | | instrument control |

These examples are not comprehensive and are not intended to be limiting.

Master-slave communication is a % ell established art with a long history and presents no challenges to those of ordinary skill. Such communication can be implemented with wires (typically using the RS-485 physical layer) or wirelessly in any modality. The unique identifier for the addressed base can be implemented in a variety of ways. The primary requirement is that the base identifier and the transactional data (command, parameter(s), and response(s)) must not be confused with each other. In a preferred implementation to avoid confusion, the master node transmits the unique ID in 9-bit serial form with bit 9 set to logic level 1 and the command and any parameters in 8-bit serial form. 8-bit serial data are not perceived by bases listening in 9-bit mode that also expect the 9^{th} bit to be set. When the addressed base recognizes its ID number with the 9^{th} data bit set it immediately switches to 8-bit mode and receives the command and any associated parameters. When it responds, it does so in 9-bit mode with the 9^{th} bit set to logic level 1, addressing the master node with the master node's address. Both the selected base and the master node then switch to 8-bit mode for the rest of the transaction. If the unique identifier is a binary byte, up to 255 bases can be addressed (256 minus 1 address for the master node, which is customarily assigned zero). If two bytes are used for the identifier, up to 65535 bases can be selected. This protocol does not prohibit the bases from addressing and communicating with one another if required.

The master node and the bases communicate using integrity checks. These integrity checks can take any of a variety of forms that are familiar to those with ordinary skill in this art. Examples include simple checksums, cyclic redundancy checks, and error-correcting (Hamming) codes.

Transmission of acquired data from the base to the master node can take any of several different forms. In one preferred implementation, the data transmitted by the base in response to the D command, or other command code with equivalent functionality, transmits all data acquired by the base in binary or ASCII form with fields delimited by explicit delimiters or by field length. In an alternative implementation, specific commands, or a parameter of a command, cause the base to send different items of data.

In a preferred configuration, environmental variables, by way of non-limiting example, ambient temperature and relative humidity, are also read by the CPU 004, either via the analog to digital interface 006 or (as shown in FIG. 1) by a direct digital link, for example, via a digital combined relative humidity and temperature sensor such as the SHT11 (Sensirion, Westlake Village, Calif.).

In a preferred configuration, the default data string transmitted from the base on request to the master node, by way of non-limiting example, includes the following:

The responding base's ID number

The telemeter ID number to which the base is assigned

The most recent calibration date of the telemeter

The most recent measured frequency of the telemeter in Hz

The antenna number giving best reception

The number of consecutive pulses used for the most recent frequency analysis

The comparator setting, proportional to signal strength

The telemeter temperature, calculated as described above, in ° C.

The number of self-similar temperature readings in the circular buffer

The voltages at the analog inputs, in volts

The temperature and relative humidity measured at the base

The number of switch closures or input pulses recorded from an external source

The state of the digital output port

This invention has been described in an illustrative manner, and it is to be understood that the terminology used is intended to be in the nature of description, rather than limitation. Obviously, many modifications and variations of the present invention are possible in light of the above teachings and one of ordinary skill in the art, in light of this teaching, can generate additional embodiments and modifications without departing from the spirit of or exceeding the scope of the claims of this invention. Therefore, it is to be understood that within the scope of the appended claims, the invention may be practiced otherwise than as specifically described. Accordingly, it is to be understood that the drawings and descriptions herein are proffered by way of example to facilitate comprehension of the invention and should not be construed to limit the scope thereof.

It is emphasized that the Abstract is provided to comply with 37 C.F.R § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter ties in less than all features of a single disclosed embodiment. Thus the following claims are hereby incorporated into the Description of Embodiments of the Invention, with each claim standing on its own as a separate preferred embodiment.

1. A telemetry base for receiving signals from at least one telemeter implanted in at least one animal, the base comprising
a) a plurality of antennae to receive radiofrequency (RF) signals from the telemeter(s);
b) a plurality of multiplexers connected to the antennae to increase the RF signal strength;
c) at least one receiver circuit capable of processing RF signals from the antennae into electrical impulses;
d) a central processing unit (CPU) to receive and convert the electrical impulses into at least one parameter such as temperature;
e) at least one digital address bus connected to the CPU and the multiplexer to select the antenna based on the best signal integrity of the antenna;
f) a display to show the current parameters from the telemeters for analysis by the operator; and
g) at least one analog-to-digital interface for receiving data from other external sensors.

2. The telemetry base of claim 1 further comprising at least one counter input line for external peripheral equipment.

3. The telemetry base of claim 1 further comprising at least one digital output line for controlling external instrumentation.

4. The digital output line of claim 3 controlling buzzers, lights, feeding hoppers or other serially controlled instruments.

5. The display of the telemetry base of claim 1 further being capable of displaying at least one reading related to at least one signal from at least one implanted telemeter.

6. A method of receiving signals from at least one implanted telemeter, the method comprising
a) providing a telemetry base comprising
i) a plurality of antennae to receive radiofrequency (RF) signals from the telemeter(s);
ii) a plurality of multiplexers connected to the antennae to increase the RF signal strength;
iii) at least one receiver circuit capable of processing RF signals from the antennae into electrical impulses;
iv) a central processing unit (CPU) to receive and process the electrical impulses into at least one parameter such as temperature;
v) at least one digital address bus connected to the CPU and the multiplexer to select the antenna based on the best signal integrity of the antenna;
vi) a display to show the current parameters from the telemeters for analysis by the operator, and
vii) at least one analog-to-digital interface for receiving data from other external sensors;
b) receiving RF signals from implanted telemeters via a plurality of antennae;
c) transmitting the RF signals from the antennae to a multiplexer;
d) processing the RF signals in a receiver circuit into brief electrical impulses;
e) transmitting the electrical impulses to the computer processing unit (CPU);
f) comparing the electrical impulses from one antenna in the CPU against a variable, built-in reference voltage;
g) adjusting the reference voltage so that the comparator fires repeatedly within the expected range of the telemeter's modulations frequency; and
h) changing antennae until the best reference voltage is found by selecting antennae through a digital address bus.
